(19) United States
(12) Patent Application Publication
(10) Pub. No.: US 2009/0063841 A1
(43) Pub. Date: Mar. 5, 2009

(54) MOTHERBOARD, COMPUTER SYSTEM AND MULTI-MONITORING METHOD THEREOF

(75) Inventor: Chih-Sheng Chien, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/192,133

(22) Filed: Aug. 15, 2008

(30) Foreign Application Priority Data
Aug. 30, 2007 (TW) 96132222

(51) Int. Cl. G06F 9/24

(52) U.S. Cl. 713/2

(57) ABSTRACT

A computer system includes a center processor, a monitoring unit, a water-cooling system and a basic input output system (BIOS) unit. The monitoring unit is coupled to the central processor, and it is used for monitoring a plurality of processor working states of the central processor and generating a plurality of signals. The water-cooling system is coupled to the monitoring unit, and then the monitoring unit is allowed to monitor a plurality of system working states of the water-cooling, system, wherein each of the system working states is respectively corresponding to one of the processor working states. The BIOS unit is coupled to the monitoring unit, and it is used for outputting a plurality of control commands to adjust the operation of the central processor and the water-cooling system according to the signals and the setting value of a user.

### CROSS-REFERENCE TO RELATED APPLICATION

This application claims the priority benefit of Taiwan application serial no. 96132222, filed on Aug. 30, 2007. The entirety of the above-mentioned patent application is hereby incorporated by reference herein and made a part of specification.

### BACKGROUND OF THE INVENTION

1. Field of the Invention

The invention relates to a computer system and a monitoring method thereof and, more particularly, to a motherboard which utilizes a basic input output system (BIOS) to monitor a water-cooling system, a computer system and a multi-monitoring method thereof.

2. Description of the Related Art

Along with the continuous progress of the semiconductor technology, the volume of an integral circuit (IC) element becomes smaller and smaller, and the operating speed becomes faster and faster. It is well-known that when a circuit works, the temperature of electronic elements will increase. Especially, along with the increase of the operating speed of the IC element, the heat generation condition is more serious. For IC elements used by computer hardware, a plurality of IC elements are usually used to form a chip module to execute some specific functions. Since the high working temperature easily causes the IC element to do a false action and even causes the IC element to be burned out, the control over the temperature of the IC element is an important subject.

For a water-cooling system which becomes popular gradually at present, if the computer system utilizes water to dissipate heat, a user usually additionally installs a monitoring panel at a five and a quarter expansion slot on a motherboard to monitor the water temperature, the water level and the flow speed of the water-cooling system from the monitoring panel. However, it is inconvenient for the user to monitor the water cooling system via an external hardware interface.

### BRIEF SUMMARY OF THE INVENTION

The invention provides a motherboard, a computer system and a multi-monitoring method thereof. In the invention, a water-cooling system can be monitored without an additional monitoring panel, and therefore, inconvenience in usage decreases and the cost of accessories also decreases.

The invention provides a motherboard capable of monitoring a water-cooling system. The motherboard includes a monitoring unit and a basic input output system (BIOS) unit. The monitoring unit is coupled to the water-cooling system, and it is used for monitoring a plurality of system working states of the water-cooling system and outputting a plurality of signals. The BIOS unit is coupled to the monitoring unit, and it is used for outputting a plurality of control commands according to the signals and the setting value of a user to adjust the working states of the water-cooling system.

The invention provides a computer system. The computer system includes a central processor, a monitoring unit, a water-cooling system and a BIOS unit. The monitoring unit is coupled to the central processor, and it is used for monitoring a plurality of processor working states of the central processor and generating a plurality of signals. The water-cooling system is coupled to the monitoring unit, and then the monitoring unit is allowed to monitor a plurality of system working states of the water-cooling system. Each of the system working states is respectively corresponding to one of the processor working states. The BIOS unit is coupled to the monitoring unit, and it is used for outputting a plurality of control commands according to the signals and the setting value of a user to adjust the operation of the central processor and the water-cooling system.

The invention provides a multi-monitoring method for a computer system. The method includes the step of providing a monitoring method for monitoring a plurality of processor working states of a central processor of the computer system. The monitoring method is applied to a water-cooling system of the computer system to synchronously monitor the central processor and the water-cooling system.

In the invention, via the monitoring unit and the BIOS unit, the processor working states of the computer system and the system working states of the water-cooling system can be monitored. The operation of the central processor and the water-cooling system can be adjusted according to the working states and the setting value of a user. In the invention, the water-cooling system can be monitored without an additional monitoring panel, and therefore, inconvenience in usage decreases and the cost of accessories also decreases.

These and other features, aspects, and advantages of the present invention will become better understood with regard to the following description, appended claims, and accompanying drawings.

### BRIEF DESCRIPTION OF THE SEVERAL VIEWS OF THE DRAWINGS

FIG. 1 is a block diagram showing a computer system according to one embodiment of the invention;

FIG. 2 is a flow chart showing a multi-monitoring method for a computer system according to one embodiment of the invention; and

FIG. 3 is a flow chart showing a multi-monitoring method for a computer system according to another embodiment of the invention.

### DETAILED DESCRIPTION OF THE EMBODIMENTS

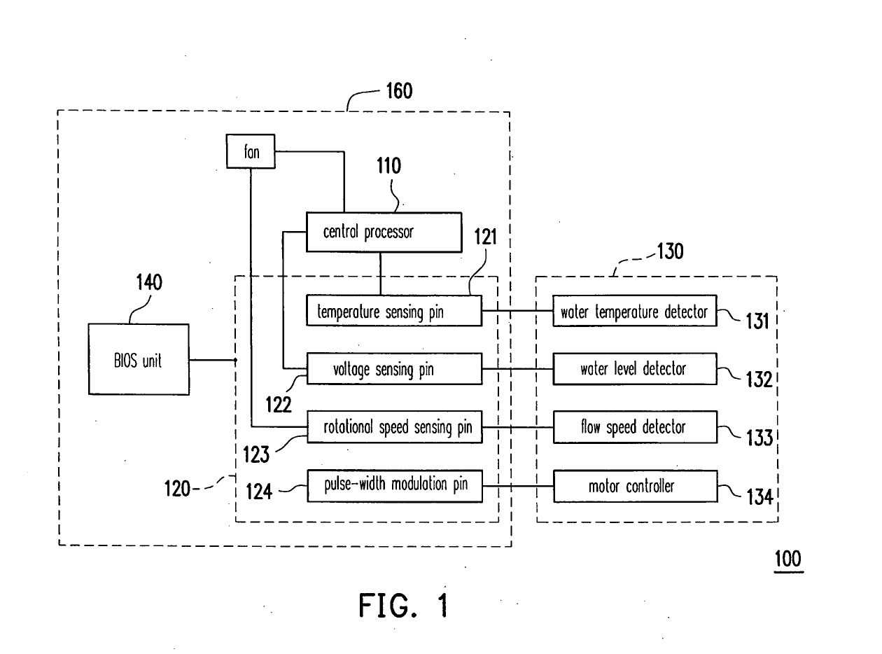

FIG. 1 is a block diagram showing a computer system according to one embodiment of the invention. As shown in FIG. 1, a computer system 100 provided in the embodiment includes a central processor 110, a monitoring unit 120, a water-cooling system 130 and a basic input output system (BIOS) unit 140. In the embodiment, the central processor 110, the monitoring unit 120 and the BIOS unit 140 may be provided on a motherboard 160.

Generally speaking, the monitoring unit 120 may be coupled to the central processor 110 to monitor processor working states of the central processor 110 and output a plurality of signals. For example, the monitoring unit 120 can monitor the working temperature and the working voltage of the central processor 110 and the rotational speed of a fan connected to the central processor 110 and output a temperature signal, a voltage signal and a rotational speed signal.

In the embodiment, the monitoring unit 120 not only can monitor the processor working states of the central processor 110 but also can monitor system working states of the water-cooling system 130. For example, the monitoring unit 120 can detect the water temperature, the water level and the fluid flow speed of the water-cooling system 130.

Generally speaking, the monitoring unit 120 usually includes a temperature sensing pin 121, a voltage sensing pin 122 and a rotational speed sensing pin 123 which can be coupled to the central processor 110 to respectively detect the working temperature of the central processor 110, the working voltage of the central processor 110 and the rotational speed of the fan connected to the central processor 110 and output the temperature signal, the voltage signal and the rotational speed signal. In the embodiment, the temperature sensing pin 121, the voltage sensing pin 122 and the rotational speed sensing pin 123 can farther be coupled to the water-cooling system 130 to detect the water temperature, the water level and the fluid flow speed of the water-cooling system 130.

The water-cooling system 130 may be provided with a water temperature detector 131, a water level detector 132 and a flow speed detector 133. The temperature sensing pin 121 can be coupled to the water temperature detector 131 to detect the water temperature of the water-cooling system 130. The voltage sensing pin 122 and the rotational speed sensing pin 123 can be respectively coupled to the water level detector 132 and the flow speed detector 133 to respectively detect the water level and the fluid flow speed of the water-cooling system 130.

The water temperature detector 131 is used for detecting the water temperature of the water-cooling system 130, and it outputs a corresponding temperature signal. The water level detector 132 is used for detecting the water level of the water-cooling system 130, and it outputs a corresponding voltage signal. The voltage signal changes according to the height of the water level. That is, when the water level is high, the voltage value of the voltage signal outputted by the water level detector 132 is great; when the water level is low, the voltage value of the voltage signal outputted by the water level detector 132 is small.

The flow speed detector 133 is used for detecting the fluid flow speed of the water-cooling system 130, and it outputs a corresponding rotational speed signal. Therefore, the monitoring unit 120 can utilize the temperature sensing pin 121, the voltage sensing pin 122 and the rotational speed sensing pin 123 which are respectively coupled to the water temperature detector 131, the water level detector 132 and the flow speed detector to effectively monitor the system working states of the water-cooling system 130.

Since the water temperature of the water-cooling system 130 is corresponding to the temperature of the central processor 110, the temperature sensing pin 121 of the monitoring unit 120, which is primarily used to be coupled to the central processor 110, can also be coupled to the water-cooling system 130. In this way, the monitoring unit 120 can measure the temperature of the water-cooling system 130 via the temperature sensing pin 121.

Similarly, the fluid flow speed in the water-cooling system 130 is corresponding to the rotational speed of the fan connected to the central processor 110, and the water level of the water-cooling system 130 is corresponding to the working voltage of the central processor 110. Therefore, the monitoring unit 120 can sense the fluid flow speed and the water level of the water-cooling system via the rotational speed sensing pin 123 and the voltage sensing pin 122, respectively.

As shown in FIG. 1, the BIOS unit 140 is coupled to the monitoring unit 120, and it is used for outputting a plurality of control commands via the monitoring unit 120 according to the signal generated by the monitoring unit 120 and the setting value of a user to adjust the operation of the central processor 110 and the water-cooling system 130.

Generally speaking, most motherboards utilize fans to dissipate heat, and therefore, the design of monitoring temperature of the BIOS unit is mostly in connection with a fan. If a computer system utilizes a fan to dissipate heat, the BIOS unit can monitor the rotation speed of the fan to avoid the overheated system caused by the low rotational speed of the fan. The BIOS unit can also provide an option for intelligently controlling a fan, and then a user can obtain balance between the noise and the temperature.

In the embodiment, the control commands may be a signal for making the computer system 100 send out an alarm signal, a signal for making the computer system 100 automatically shut down, a signal for decreasing the working frequency of the central processor 110 and a signal for adjusting the rotational speed of a motor of the water-cooling system 130.

For example, the user can set the system working states of the water-cooling system 130 via the setting image of the BIOS unit 140 first. That is, maximum upper limit values of the water temperature, the water level and the fluid flow speed (namely, values predetermined by the user) are set. Afterward, if the signals generated by the monitoring unit 120 exceed the values predetermined by the user, the BIOS unit 140 sends out the control commands via the monitoring unit 120 to change the operation of the central processor 110. For example, the computer system 100 is made send out alarm sound, automatically shut down or decrease the frequency of the central processor 110.

The user still can set the relationship between the motor and the water temperature of the water-cooling system 130 via the setting image of the BIOS unit 140 as a basis for automatically controlling the rotational speed of the motor. In the embodiment, the monitoring unit 120 and the water-cooling system 130 include a pulse-width modulation pin 124 and a motor controller 134, respectively. The pulse-width modulation pin 124 can output a modulation signal according to the signal which is outputted by the BIOS unit 140 to adjust the rotational speed of the motor. The motor controller 134 is coupled to the pulse-width modulation pin 124 and is used for receiving the modulation signal to adjust the rotational speed of the motor of the water-cooling system 130.

For example, when the water temperature of the water-cooling system 130 increases, the BIOS unit 140 can output a signal for adjusting the rotational speed of the motor (namely, a signal for increasing the rotational speed of the motor) to the monitoring unit 120. Afterward, the monitoring unit 120 outputs the modulation signal from the pulse-width modulation pin 124 to the motor controller 134 of the water-cooling system 130 according to the signal, and then the rotational speed of the motor increases to increase the speed of heat dissipation.

When the water temperature of the water-cooling system 130 decreases, the BIOS unit 140 can output a signal for adjusting the rotational speed of the motor (namely, a signal for decreasing the rotational speed of the motor) to the monitoring unit 120. Afterward, the monitoring unit 120 outputs a modulation signal from the pulse-width modulation pin 124 to the motor controller 134 of the water-cooling system 130 according to the signal, and then the rotational speed of the motor decreases to decrease the power consumption of the water-cooling system 130 and the noise generated by the motor.

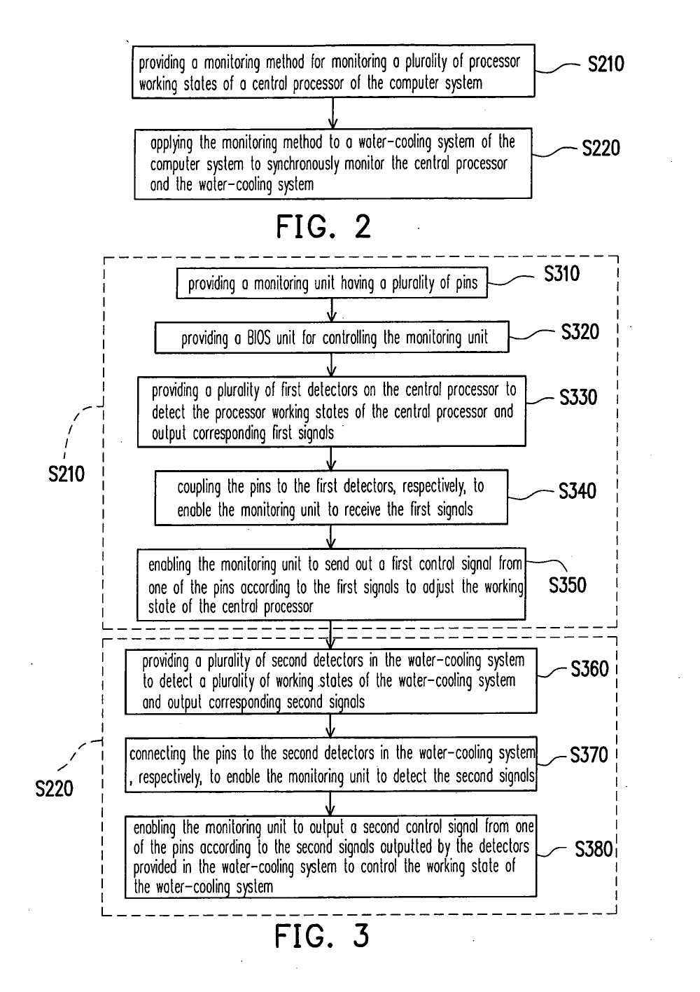

A multi-monitoring method for a computer system can be concluded from the above embodiment. FIG. 2 is a flow chart showing a multi-monitoring method for a computer system according to one embodiment of the invention. As shown in FIG. 2, in the step S210, a monitoring method is provided for monitoring a plurality of processor working states of the central processor of the computer system.

In the step S220, the monitoring method is applied to the water-cooling system of the computer system to synchronously monitor the central processor and the water-cooling system. In this way, in the embodiment, the working states of the central processor and the water-cooling system can be synchronously monitored to achieve the objective of multi-monitoring the computer system.

To further clearly describe the steps of the multi-monitoring method for the computer system, an embodiment is described hereinbelow to illustrate the detailed flow path of the multi-monitoring method of the invention. FIG. 3 is a flow chart showing a multi-monitoring method for a computer system according to another embodiment of the invention. As shown in FIG. 3, first, in the step S310, a monitoring unit having a plurality of pins is provided. The pins can be a temperature sensing pin, a voltage sensing pin, a rotational speed sensing pin and a pulse-width modulation pin.

Afterward, in the step S320, a plurality of first detectors are provided on a central processor, and they are used to detect a plurality of processor working states of the central processor and output corresponding first signals. The processor working states may be the working temperature of the central processor, the working voltage of the central processor and the rotational speed of a fan connected to the central processor. The first signals may be a temperature signal, a voltage signal and a rotational speed signal.

In the step S330, the pins are coupled to the first detectors, respectively, to enable the monitoring unit to respectively receive the temperature signal, the voltage signal and the rotational speed signal via the temperature sensing pin, the voltage sensing pin and the rotational speed sensing pin.

Afterward, the step S340 is executed. That is, a BIOS unit is provided to control the monitoring unit. That is, the BIOS unit can receive the first signals via the monitoring unit, and a user can know the working states of the central processor via the setting image of the BIOS.

Next, the user can further set predetermined values for the processor working states of the central processor in the setting image of the BIOS unit, and the BIOS can provide a first control signal to the monitoring unit according to the predetermined values and the first signals. Afterward, the monitoring unit outputs the first control signal from one of its pins to adjust the working states of the central processor (the step S350). For example, the working temperature of the central processor, the working voltage of the central processor and the rotational speed of the fan connected to the central processor can be adjusted.

The first control signal may be a signal for making the computer system send out an alarm sound, a signal for making the computer system automatically shut down or a signal for decreasing the working frequency of the central processor. For example, when the BIOS unit finds that the first signal received by the monitoring unit exceeds the setting value of the user, it outputs the first control signal via the monitoring unit to make the computer system send out an alarm sound, make the computer system automatically shut down or decrease the working frequency of the central processor further to protect the computer system.

As shown in FIG. 3, in the step S360, a plurality of second detectors are provided in the water-cooling system to detect a plurality of system working states of the water-cooling system and output corresponding second signals. The second detectors may be a water temperature detector, a water level detector and a flow speed detector. The system working states of the water-cooling system may be the water temperature, the water level and the fluid flow speed of the water-cooling system, and the second signals may also be a temperature signal, a voltage signal and a rotational speed signal.

In the embodiment, the water temperature detector is used for detecting the water temperature of the water-cooling system and outputting a corresponding temperature signal. The water level detector is used for detecting the water level of the water-cooling system and outputting a corresponding voltage signal. The flow speed detector is used for detecting the fluid flow speed of the water-cooling system and outputting a corresponding rotational speed signal. Therefore, the monitoring unit can utilize the voltage sensing pin and the rotational speed sensing pin which are respectively coupled to the water level detector and the flow speed detector to effectively monitor the system working states of the water-cooling system.

In the step S370, the above pins are connected to the second detectors of the water-cooling system, respectively, to enable the monitoring unit to detect the second signals. In detail, the monitoring unit utilizes the temperature sensing pin, the voltage sensing pin and the rotational speed sensing pin to respectively detect the water temperature, the water level and the fluid flow speed of the water-cooling system to enable the computer system to synchronously monitor the working states of the central processor and the water-cooling system.

Afterwards, in the step S380, according to the second signals outputted by the second detector provided in the water-cooling system, the monitoring unit outputs the second control signal via one of the pins to control the working state of the water-cooling system. The second control signal may be a signal for adjusting the rotational speed of the motor in the water-cooling system (that is, the rotational speed of the motor is increased or decreased). In this way, the speed for dissipating heat for the computer system increases, or the noise generated by the motor is decreased.

To sum up, in the invention, the monitoring unit and the BIOS unit are used to synchronously monitor the working states of the central processor and the system working states of the water-cooling system. The BIOS unit can adjust working conditions of the central processor and the water-cooling system according to the different working states and the setting values of the user. In the invention, the computer system does not need an additional monitoring device to monitor the water-cooling system, and therefore, the inconvenience in usage decreases and the cost of accessories also decreases.

In the invention, the computer system automatically controls the rotational speed of the motor of the water-cooling system by adjusting the relationship between the motor and the water temperature. When the BIOS unit receives a signal generated by the monitoring unit, and the signal exceeds the setting value of the user, it makes the computer system send out alarm sound, automatically shut down or decrease the working frequency of the central processor further to protect the computer system.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A motherboard capable of monitoring a water-cooling system, the motherboard comprising:
a monitoring unit which is coupled to the water-cooling system and is used for monitoring a plurality of system working states of the water-cooling system and outputting a plurality of signals; and
a basic input output system (BIOS) unit which is coupled to the monitoring unit and is used for outputting a plurality of control commands to adjust the working states of the water-cooling system according to the signals and the setting value of a user.

2. The motherboard according to claim 1, wherein the signals comprise a temperature signal, a voltage signal and a rotational speed signal.

3. The motherboard according to claim 2, wherein the monitoring unit comprises:
a temperature sensing pin for outputting the temperature signal;
a voltage sensing pin for outputting the voltage signal; and
a rotational speed sensing pin for outputting the rotational speed signal.

4. The motherboard according to claim 1, wherein the monitoring unit further comprises:
a pulse-width modulation pin for outputting a modulation signal to adjust the rotational speed of a motor in the water-cooling system according to one of the control commands.

5. A computer system comprising:
a central processor;
a monitoring unit which is coupled to the central processor and is used for monitoring a plurality of processor working states of the central processor and outputting a plurality of signals;
a water-cooling system which is coupled to the monitoring unit and enables the monitoring unit to be allowed to monitor a plurality of system working states of the water-cooling system, wherein each system working states is respectively corresponding to one of the processor working states; and
a basic input output system (BIOS) unit which is coupled to the monitoring unit and is used for outputting a plurality of control commands via the monitoring unit to adjust the operation of the water-cooling system and the central processor according to the signals and the setting value of a user.

6. The computer system according to claim 5, wherein the signals comprise a temperature signal, a voltage signal and a rotational speed signal.

7. The computer system according to claim 6, wherein the monitoring unit comprises:
a temperature sensing pin for outputting the temperature signal;
a voltage sensing pin for outputting the voltage signal; and
a rotational speed sensing pin for outputting the rotational speed signal.

8. The computer system according to claim 5, wherein the system working states comprise a water temperature, a water level and a fluid flow speed of the water-cooling system.

9. The computer system according to claim 8, wherein the water-cooling system further comprises:
a water temperature detector for detecting the water temperature of the water-cooling system and outputting a corresponding temperature signal;
a water level detector for detecting the water level of the water-cooling system and outputting a corresponding voltage signal; and
a flow speed detector for detecting the fluid flow speed of the water-cooling system and outputting a corresponding rotational speed signal.

10. The computer system according to claim 5, wherein the monitoring unit further comprises:
a pulse-width modulation pin for outputting a modulation signal according to one of the control commands.

11. The computer system according to claim 10, wherein the water-cooling system further comprises:
a motor controller which is coupled to the pulse-width modulation pin and is used for adjusting the rotational speed of a motor in the water-cooling system according to the modulation signal.

12. The computer system according to claim 5, wherein the processor working states comprise a working temperature of the central processor, a working voltage of the central processor and a rotational speed of a fan connected to the central processor.

13. The computer system according to claim 5, wherein the control commands comprise a signal for making the computer system send out an alarm sound, a signal for making the computer system automatically shut down signal, a signal for decreasing the working frequency of the central processor and a signal for adjusting the rotational speed of a motor.

14. A multi-monitoring method for a computer system, the multi-monitoring method comprising the steps of:
providing a monitoring method for monitoring a plurality of processor working states of a central processor of the computer system; and
applying the monitoring method to a water-cooling system of the computer system to synchronously monitor the central processor and the water-cooling system.

15. The multi-monitoring method according to claim 14, wherein the multi-monitoring method comprises the steps of:
providing a monitoring unit having a plurality of pins;
providing a plurality of first detectors on the central processor to detect the processor working states of the central processor and output corresponding first signals;
coupling the pins to the first detectors, respectively, to enable the monitoring unit to receive the first signals; and
enabling the monitoring unit to send out a first control signal from one of the pins according to the first signals to adjust the working states of the central processor.

16. The multi-monitoring method according to claim 15, wherein the step of applying the monitoring method to the water-cooling system comprises the steps of:
providing a plurality of second detectors in the water-cooling system to detect a plurality of system working states of the water-cooling system and output corresponding second signals;
connecting the pins to the second detectors in the water-cooling system, respectively, to enable the monitoring unit to detect the second signals; and
enabling the monitoring unit to output a second control signal from one of the pins according to the second signals outputted by the second detectors provided in the water-cooling system to control the working states of the water-cooling system.

17. The multi-monitoring method according to claim 15 further comprising the step of providing a BIOS unit for controlling the monitoring unit.

18. The multi-monitoring method according to claim 15, wherein the processor working states comprise a working temperature of the central processor, a working voltage of the central processor and a rotational speed of a fan connected to the central processor.

19. The multi-monitoring method according to claim 15, wherein the first control signals comprise a signal for sending out an alarm sound, an automatic shutdown signal or a signal for decreasing the working frequency of the central processor.

20. The multi-monitoring method according to claim 15, wherein the first signals comprise a temperature signal, a voltage signal and a rotational speed signal.
